(19) United States
(12) Patent Application Publication
(10) Pub. No.: US 2024/0221546 A1
(43) Pub. Date: Jul. 4, 2024

(54) MODULAR SIGN BOARD WITH AUTOMATED WIRELESS EMERGENCY ASSISTANCE SYSTEM

(71) Applicant: Gaurav Batta, Scottsdale, AZ (US)

(72) Inventor: Gaurav Batta, Scottsdale, AZ (US)

(21) Appl. No.: 18/602,922

(22) Filed: Mar. 12, 2024

Related U.S. Application Data
(63) Continuation-in-part of application No. 17/971,469, filed on Oct. 21, 2022.
(60) Provisional application No. 63/451,651, filed on Mar. 13, 2023.
(60) Provisional application No. 63/270,574, filed on Oct. 22, 2021.

(51) Int. Cl. G09F 13/04; G09F 13/00; G09F 13/22

(52) U.S. Cl. CPC G09F 13/04; G09F 13/005; G09F 13/22

(57) ABSTRACT

An address sign can consist of a rectangular enclosure with removable, illuminated alphanumeric characters attached to the front of the enclosure, an electronic control module positioned inside the enclosure, wherein the electronic control module includes a wireless communication unit configured to communicate with a series of electronic devices within a geographical area, a satellite communication unit, and a cellular communication unit, and wherein the electronic control module is configured to transmit data to a variety of external devices.

### CROSS REFERENCE TO RELATED APPLICATIONS

This application claims priority to and the benefit of U.S. Provisional Patent Application Ser. No. 63/451,651 filed Mar. 13, 2023. This application further claims priority to and the benefit of U.S. patent application Ser. No. 17/971,469 filed Oct. 21, 2022, which, in turn, claims priority to U.S. Provisional Patent Application Ser. No. 63/270,574 filed Oct. 22, 2021, entitled “Modular sign board with wireless emergency warning system,” the disclosure of which is incorporated herein by reference in its entirety for all purposes.

### FIELD

The present disclosure relates to illuminated sign devices, emergency monitoring, and warning systems.

### BACKGROUND

Currently, every year hundreds of thousands of people lose their lives & property to sudden and unexpected grave emergencies such as strokes, heart attacks, slips, falls, overdoses, & fires. When such emergencies strike, people don't always get the chance of calling someone, or requesting emergency assistance by dialing 911. There are various apparent bottlenecks that preclude people from successfully getting help, such as being physically impaired by sudden onset of paralysis, or being physically incapacitated with no one around to notice and get the needed help, or lastly not being present at the property to notice gas leak or other fire outbreak that threatens property.

### SUMMARY

The present invention seeks to provide a solution that eliminates the loss of life and property by automatically getting emergency assistance without any user intervention.

This extraordinary functionality is achieved by augmenting additional components and improving upon the previously developed solution as described in U.S. patent application Ser. No. 17/971,469. The solution carries forward the entire scope of functionality as previously described, herein incorporated by reference. The scope of previous invention has been included in detail herein as appropriate for clearer explanation, to reflect on additional exceptional utility gained from improvements.

The previous invention provided a solution to this problem(s) by providing a modular sign board device with connectors that allow for interchangeable numbers (or Alphabets) that can be attached to its' front plate to represent any address by the user. The individual number units include a connector that can interface with the connector(s) of the front plate. The device can then provide electrical power to illuminate the numbers ensuring high legibility. The device is a smart device with built in circuitry for wireless signal transmission, and under certain conditions, allows the numbers, or front plate, or both to be illuminated in different colors & patterns to convey distress, attract attention, and be distinctly recognizable, such as in one embodiment flashing red & blue to indicate an emergency.

The present invention, augments wireless signal transmission & multi-protocol microcontroller unit to enable two-way multi-protocol communication. Addition of satellite communication module, cellular communication module, GPS receiver module, and a Thread and/or Matter protocol compatible WiFi and/or Bluetooth Microcontroller Unit, enable the present invention to monitor and communicate with plethora of smart home & communication enabled devices, gaining the ability (a) to detect grave emergencies such as fire outbreak from a fire alarm(s), or abnormal heart rhythm(s), receding blood oxygen levels from devices such as fitness tracker(s), to provide a few descriptive example(s) (b) to act on the detected and/or received information of an emergency, by getting emergency assistance without any user intervention including but not limited to, communicating & notifying emergency services through satellite and/or cellular communication, providing GPS location of the emergency with any other additional details possible, communicating by text and/or push notifications on cellular devices of the household, or assigned emergency contacts, flashing Red & Blue on the modular sign board, and/or emitting an audible sound to alarm onlookers and people that may be able to assist.

Preferably, the connectors are proprietary so as to ensure ingenuity, dissuade replication of similar functional equipment, maintain closed system design & safety through complete control over design intent and expected performance in use. An additional software app available on mobile devices will allow users to configure various aspects such as, integrate multiple smart devices of the household for communication, assign emergency contacts, and tune device behavior to best suit their needs. The additional software app may be the same as one previously stated for the previous invention, whereby it was monitoring outbound emergency calls.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates an orthographic view of sample numbers according to one exemplary embodiment of the invention;

FIG. 2 illustrates a cross-sectional view from the back of a number according to one exemplary embodiment of the invention;

FIG. 3 illustrates an exploded-view of the enclosure according to one exemplary embodiment of the invention;

FIG. 4 illustrates the closed enclosure according to one exemplary embodiment of the invention;

FIG. 5 illustrates a sample number removably coupled to the front plate of the closed enclosure according to one exemplary embodiment of the invention;

FIG. 6 illustrates a cross-sectional view from the side of the enclosure with a sample number removably coupled to the enclosure according to one exemplary embodiment of the invention;

FIG. 7 illustrates a cross-sectional view of the front face of the enclosure according to one exemplary embodiment of the invention;

FIG. 8 illustrates an exploded-view of the electronic control module and flat back embodiment of the enclosure according to one exemplary embodiment of the invention;

FIG. 9 illustrates an exploded-view of the electronic control module and the protruding back embodiment of the enclosure according to one exemplary embodiment of the invention; and

FIG. 10 illustrates the internally housed power supply embodiment of the enclosure according to one exemplary embodiment of the invention.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, any of the above-described concepts can be used alone or in combination with any or all the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible considering the above teaching.

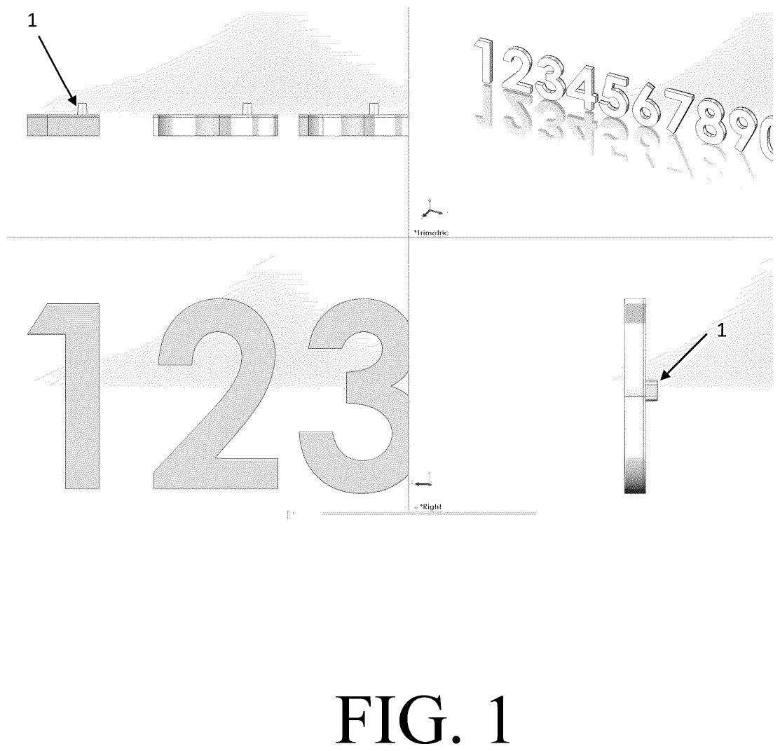

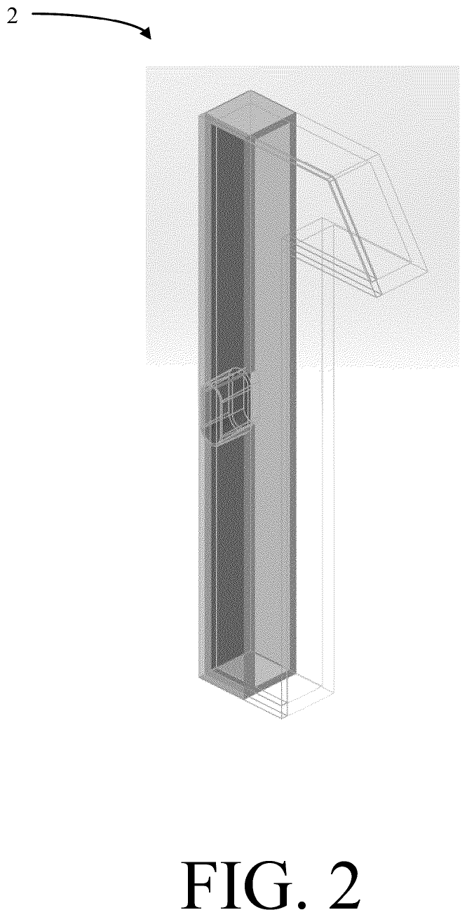

Referring to the drawings, there is shown a set of numbers in FIG. 1, highlighting a protrusion 1, that has the connector for the element 2, as shown in FIG. 2. The element 2 may instead be any other number, alphabet, or character, in any language, and is henceforth called number or character reflecting implementation as shown in current embodiment. The protrusion 1 enables the user to connect any desired number or character and holds it in place on a front-plate 3, similar to a plug and receptacle design. Preferably, element 2 is pre-fitted with a suitable light emitter, such as LED lights that can display red, green, blue, white or a combination of those. Preferably, the connector in protrusion 1 is proprietary with unique plug and receptacle to ensure safety and prevent misuse. Preferably, the plug and receptacle are shaped like a slot to assist in correctly orient the element 2.

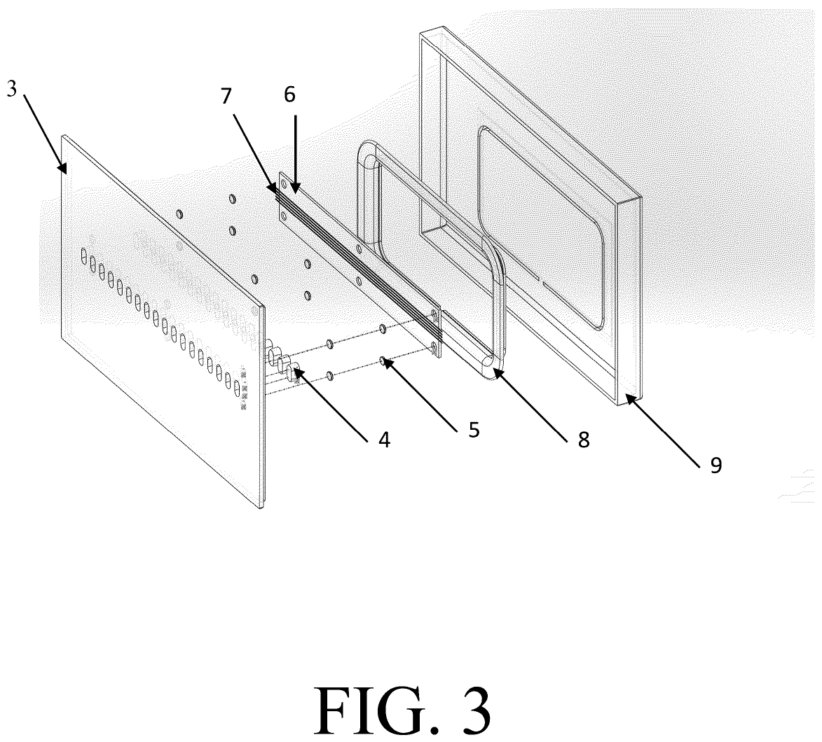

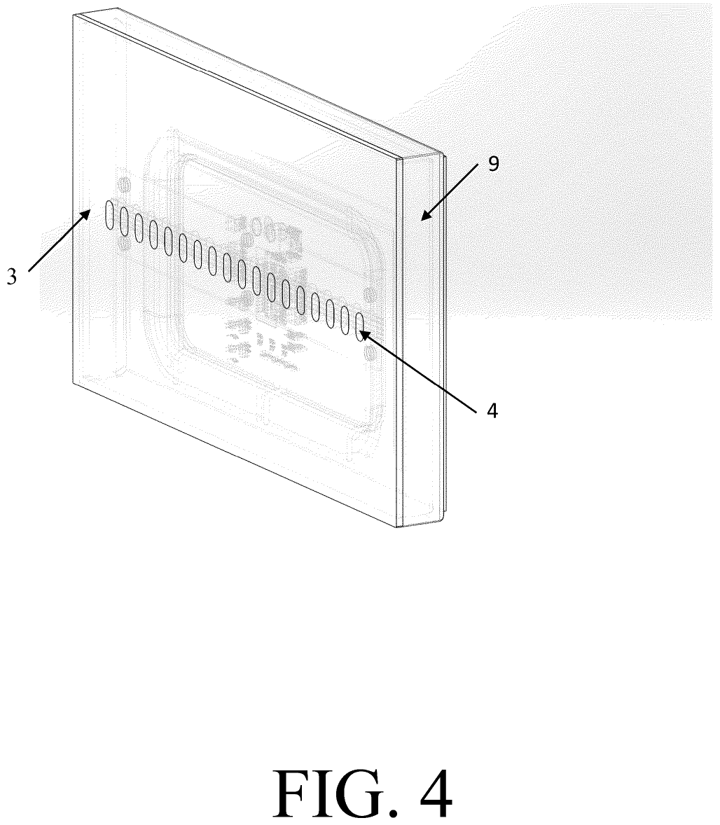

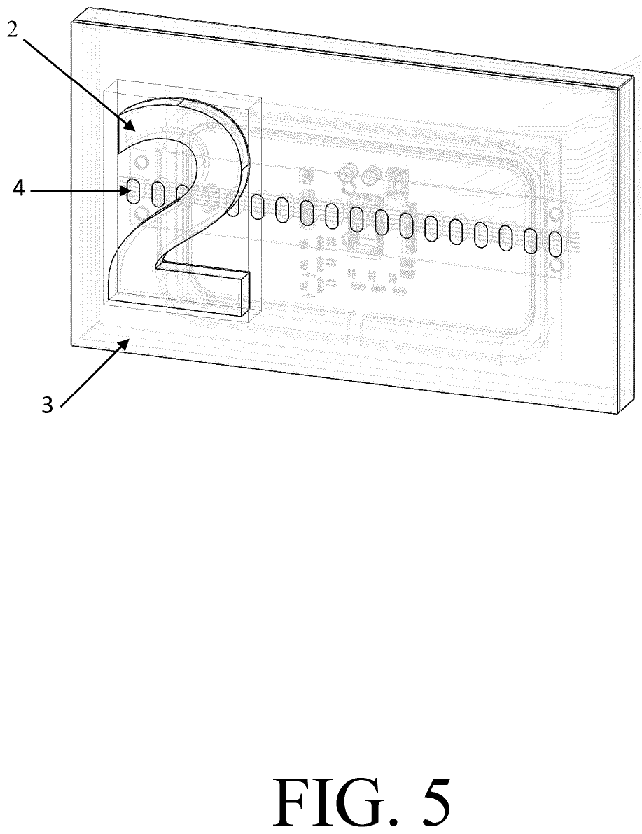

The front-plate 3 features multiple slots as shown in FIG. 3, spaced across the front to function as potential receptacles for any element(s) 2 the user may plug in. Preferably, the slots are filled with nubs 4 as in FIG. 4 that sit flush with the front surface and are finished similarly so as to be virtually indistinguishable to front plate unless inspected up close or more carefully. Thus the user can space their desired element(s) 2, by selectively removing nubs 4, while leaving remaining nubs intact. One such example of embodiment is presented in FIG. 5 that shows number “2” as element 2, plugged onto front-plate 3, occupying the space of fourth slot nub 4 with remainder slot nubs 4 left intact. The user can hence plug in as many or as few element(s) 2 as they desire to assemble their desired combination subject to available space.

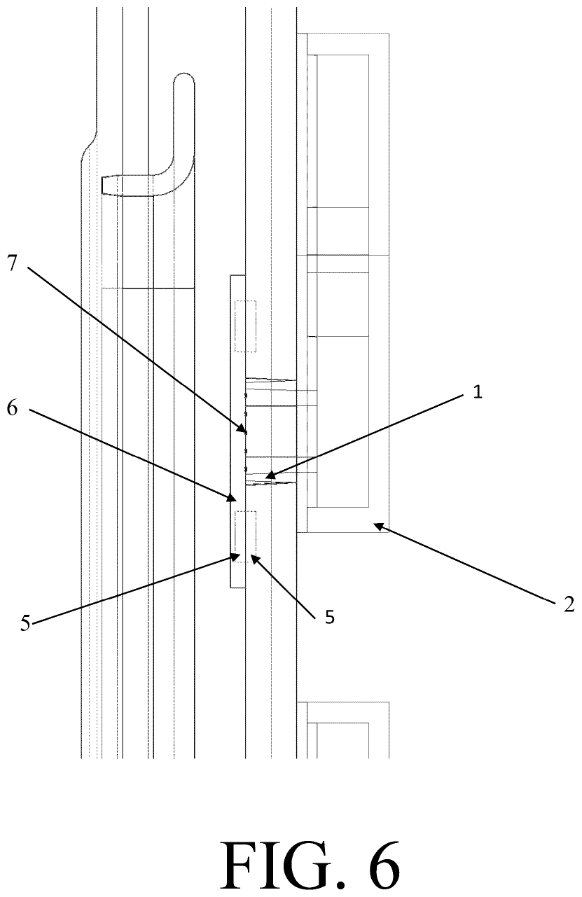

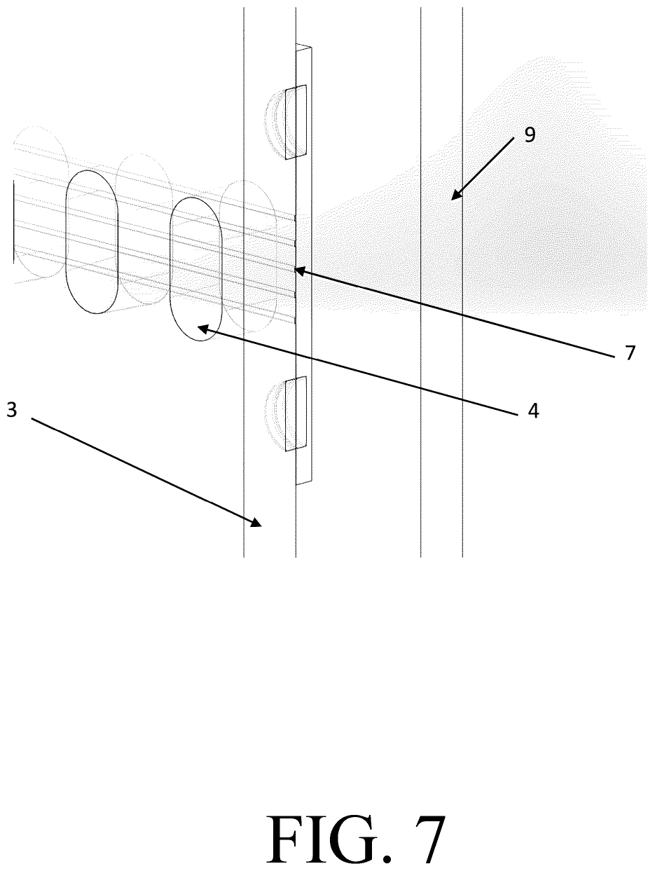

The protrusion 1 of the said element 2 is shown in cross section view in FIG. 6 plugged through space originally occupied by slot nub element 4, thereby aligning the connector contacts of protrusion 1 to conductor element 7. The conductor rail 6 facilitates interface as conductor element 7 spans across the slot nubs 4. Many implementations are possible to ensure transmission of power and any other signals from a conductor element to contacts. One such example is shown in FIGS. 6 and 7. Preferably, the conductor rail 6 is held in place with magnet(s) 5, enabling easy coupling and uncoupling as the user presses the element 2, thereby displacing the slot nub 4, which then uncouples conductor rail 6 as magnet(s) 5 are pushed farther apart.

Once the element(s) 2 have been plugged in as desired, the user can easily reattach connector rail 6 back in position, aligning conductor(s) 7 to interface with connector(s) in protrusion 1.

The conductor 7 connects to printed circuit board (“PCB”) element 10, preferably by soldered and subsequently shielded joints. The PCB element 10 controls the illumination of enclosure and characters, and has wireless communication module such as ESP32 wifi module, that can wirelessly communicate with other mobile devices. Other modules may be incorporated onto the PCB element 10, and the example provided is to communicate one embodiment of various electrical implementations. Thus when the device is connected to a wireless network, it can detect other devices on the same network. A mobile application installed by the user on their communication devices not limited to examples such as, phones, watches, and home assistants, will then be able to monitor for emergency calls such as 911, within the scope of devices located in a geo-fence perimeter. Upon detection of an emergency call, the device will then be triggered and the solid illumination of numbers will switch to red and blue illumination, preferably in flashing patterns to mimic ambulance or police vehicle light colors for a set amount of time, unless terminated by the user. Other patterns may be used, such as solid red illumination, as many combinations are possible. In another embodiment, a speaker may be added to PCB to emit auditory signal such as a siren to indicate emergency, with or without the emission of visual signals. An ambient light sensor may be added to facilitate automated illumination as it gets darker.

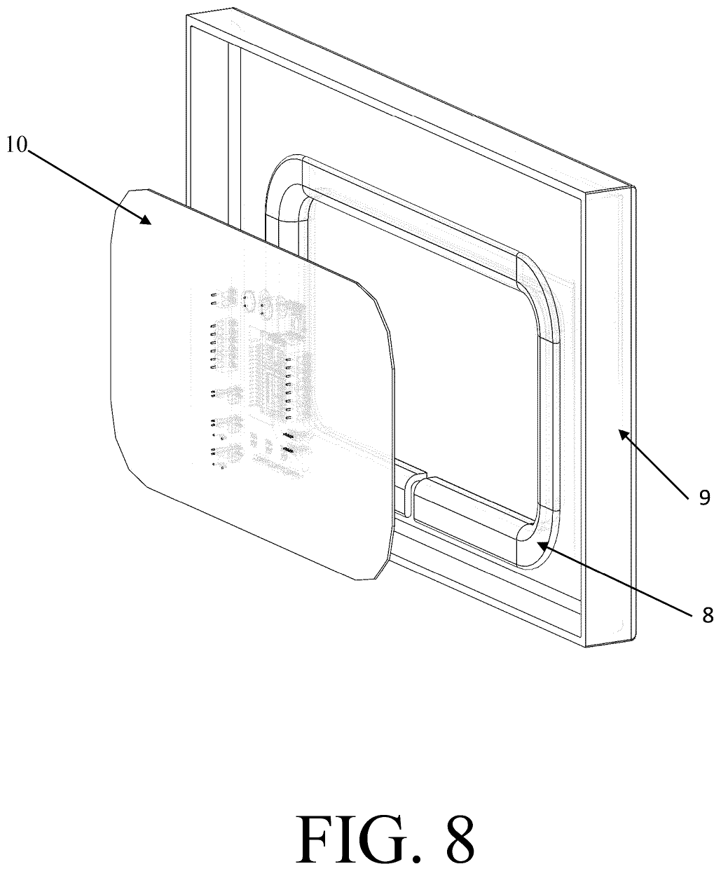

In the present invention, certain revisions are made to element 10, the PCB, with new components providing additional utility in the present invention over the previously described invention. While visual representation stays the same as in FIG. 8, the PCB incorporates a satellite communication module, such as Iridium 9603N from iridium communications Inc, that can facilitate two-way emergency communication over satellite. Additionally, the PCB includes a cellular communication module, such as Telit LE910C1-NF, that enables two way emergency communication over 3G, 4G and LTE cellular networks. Adding these two component facilitates two-way communication to get emergency assistance over satellite & cellular networks while also allowing for notifying relevant users over call, text, and push notifications. Further, the current invention incorporates a GPS receiver module, such as u-blox ZED-F9P, onto the PCB element 10, enabling high accuracy positioning information to be communicated to emergency services and relevant users. To detect emergencies, other than by way of detecting an outbound 911 call or distress signal, the present invention additionally incorporates “Thread” & “Matter” communication protocol capable WiFi Microcontroller Unit, such as CC3235SF, and/or Bluetooth Microcontroller Unit (MCUs), such as CC2652R7, from Texas Instruments. This addition to the PCB element 10, enables the present invention to communicate back & forth with numerous smart home devices (not pictured) such as fire alarms, security system, and smart locks, using “Thread” & “Matter” communication protocol. In the present invention, the aforementioned MCUs maintain the ability to communicate with wearables & communication devices such as phones, smartwatches, or smart rings & receive data directly or indirectly, enabling the present invention to play an indispensable role in saving life & property from imminent harm.

One example highlighting the full scope of incredible utility of the present invention is as follows. A wearable such as a smart watch may detect receding blood oxygen level. The present invention can receive this data directly from the wearable, or indirectly through the accompanying app, or by other means, such as wearable's app. The present invention having detected a potential emergency where the user may be incapacitated, can now push a notification to the wearable. Upon receiving no feedback, the present invention will proceed to automatically get emergency assistance utilizing satellite and/or cellular communication, while providing high accuracy positioning information along with any relevant additional information that may be helpful to identify the nature of emergency. As per scope of design, the invention will also be able to flash Red & Blue, and emit an audible alarm to signal distress, having established an emergency situation by means other than detecting a 911 call. The present invention, using the aforementioned Matter & Thread communication protocol, can communicate with devices such as a smart lock, triggering it open without any user intervention, as the incapacitated person will not be able to open it. Such elaborate functionality & interplay of devices that enables the present invention to play indispensable role in saving life & property from imminent harm, can be derived by adding the above mentioned components onto the PCB element 10 shown in the figure below. The design of PCB is omitted as it is trivial to subject of deriving above mentioned utility, and highly dependent on the choice of components by the person. Many readily available alternative components and combinations will be apparent to a person skilled in the art.

While numerous features are possible and can be added using the current invention as platform, it is not feasible to list all possible iterations and combinations, and description of one embodiment and limited examples in no way imply exhaustive scope of invention. Retaining extraordinary utility derived from the present invention, as applied to the modular sign board device, to transpose over to another invention, by removal of one or more elements such glowing house number element 2, should not be construed as novel invention, as doing so will be apparent to those skilled in the art. Furthermore, such an attempt to transpose the extraordinary utility of the present invention to other smart products such as a smart lock, or a doorbell video camera, or a phone, beyond being apparent, will yield impoverished & compromised utility in product ecosystem, considering a doorbell does not serve as identifier or distinguisher of the house to best serve emergency situations, and a phone will most likely be inside the house, and devices such as smart locks may accomplish little besides opening themselves. The present invention constitutes an ideal device for the entire house and the smart devices comprised within, serving as a suitable unmoving and fully integrated identifier of the house from outside. Any effort to transpose the utility of the present invention highlighted here, in full or in part to yield a new device, not limited to examples mentioned above, will be relatively obvious modifications to other smart products, and will be apparent to those skilled in the art, and hence should be seen within the scope of this invention.

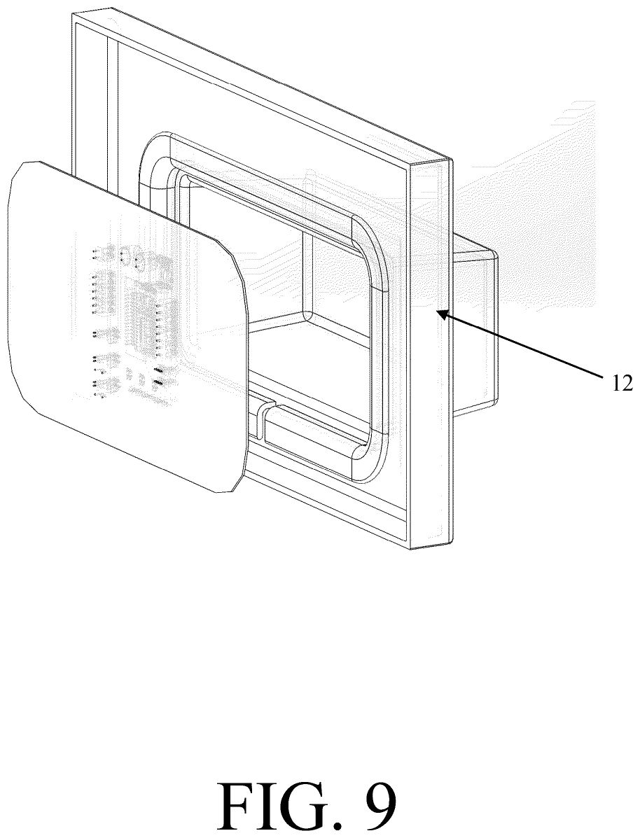

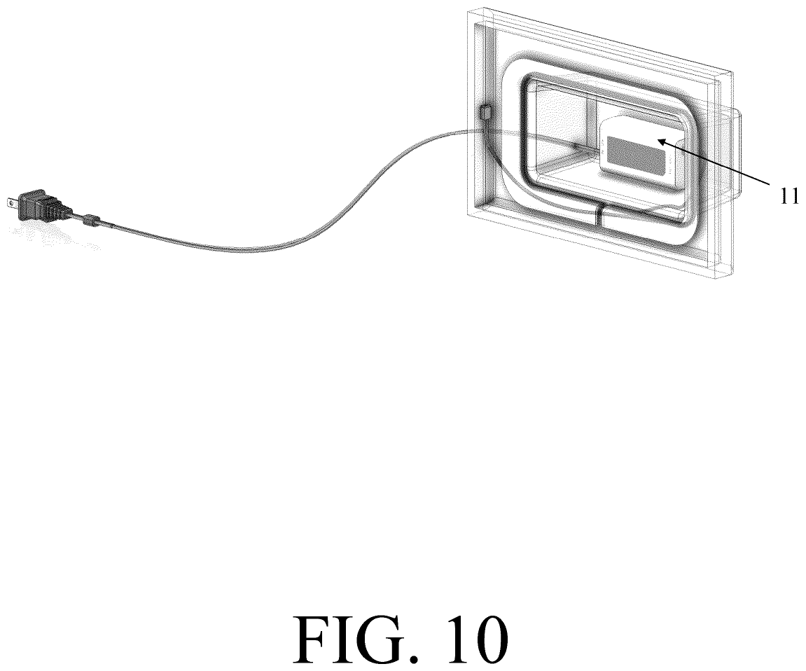

Another enclosure back element 9 is presented in FIG. 9 by way of example only, and may be used in lieu of the flat back enclosure element 9 shown previously in FIG. 8. Element 9 as shown includes additional space to accommodate the power supply element 11 within the enclosure for the users who prefer the entire assembly to be situated in the same place and have adequate space available in a wall for installation. The other embodiment of element 9 with flat back design is better suited for users who would prefer situating power supply element 11 elsewhere to run a singular wire to the enclosure preventing the enclosure from excessively protruding outward from the wall, and/or from the need to carve space into a wall for installation. FIG. 10 shows an example power supply 11, that is situated within the enclosure, but may be placed outside depending on user preferences for setup, thus delivering power to the PCB element 10.

The embodiments described above are provided by way of example only, and various other modifications will be apparent to persons skilled in the art.

What is claimed is:

1. An address sign, comprising:
a rectangular enclosure having a front face, a back face, a first side wall, a second side wall opposite to the first side wall, a top, and a bottom, wherein the front face, the back face, the first side wall, the second side wall, the top, and the bottom together define a closed space;
a plurality of alphanumeric character units removably coupled to the front face, the plurality of alphanumeric character units including a plurality of light emitting devices disposed therein;
an electronic control module positioned inside the closed space, the electronic control module comprising:
a wireless communication unit configured to communicate with a plurality of electronic devices within a geographical area;
a satellite communication module configured to facilitate two-way communication over a satellite network; and
a cellular communication module configured to facilitate two-way communication over a cellular network;
wherein the electronic control module is configured to transmit data to at least one of a plurality of external devices;
a conductor device removably coupled to the plurality of alphanumeric character units and the electronic control module and configured to transmit data from the electronic control module to the plurality of light emitting devices; and
a power supply system.
